(19) United States
(12) Patent Application Publication
(10) Pub. No.: US 2024/0301658 A1
(43) Pub. Date: Sep. 12, 2024

(54) SYSTEM AND METHOD FOR COORDINATING OPERATIONS OF A FLEET OF MACHINES AND AT LEAST ONE PROCESSING PLANT

(71) Applicant: Caterpillar Inc., Peoria, IL (US)

(72) Inventors: John Steven Harpour, Thomlands (AU); Kenneth Patrick Robinson, Brisbane (AU); Carla Wesley, Samford Village (AU)

(73) Assignee: Caterpillar Inc., Peoria, IL (US)

(21) Appl. No.: 18/181,452

(22) Filed: Mar. 9, 2023

(51) Int. Cl. E02F 9/20

(52) U.S. Cl. CPC E02F 9/2054

(57) ABSTRACT

A fleet of machines at a worksite can transport loads of material, such as ore, to a processing plant configured to process the material. A fleet management controller can control operations of the fleet of machines, while a plant management controller can control operations of the processing plant. The fleet management controller and the plant management controller can exchange data associated with the operations of the fleet of machines and the operations of the processing plant. The fleet management controller can use the data provided by the plant management controller to dynamically control operations of the fleet of machines based on the operations of the processing plant. The plant management controller can use the data provided by the fleet management controller to dynamically control operations of the processing plant based the operations of the fleet of machines and attributes of loads of material transported by the fleet of machines.

### TECHNICAL FIELD

The present disclosure relates to a system and method for management of a fleet of machines at a worksite and, more particularly, to a system and method for coordinating operations of a fleet of machines and at least one processing plant associated with the worksite.

### BACKGROUND

A fleet of machines may operate at a worksite, such as a mine site or quarry. The machines can include excavators, loaders, haul trucks, and/or other types of machines. One or more processing plants can be located at or near the worksite, and can be configured to process material delivered to the processing plants by the fleet of machines.

For example, excavators or other machines at the worksite may dig up ore that contains minerals. The ore can be loaded onto haul trucks or other mobile machines, which transport the ore to crushers associated with the processing plants. The crushers can crush the delivered ore into smaller pieces, so that other downstream elements of the processing plants can further process the crushed ore and/or extract minerals from the crushed ore.

A fleet management controller may manage operations of the fleet of machines at the worksite, for instance by providing instructions to autonomous machines and/or to human operators of semi-autonomous, remotely controlled, or manually operated machines. The fleet management controller can, for example, assign individual haul trucks to be loaded with material at particular locations within the worksite, and to deliver the material to particular crushers associated with one or more processing plants.

In the past, various systems have been developed to manage fleets of machines at worksites. For example, U.S. Pat. No. 11,244,262 to Walker et al. (hereinafter “Walker”) describes a system that uses historical delay data associated with material loading operations, material conveyance operations, and/or material processing operations to predict future delays associated with upcoming material loading operations, material conveyance operations, and/or material processing operations. However, the system described by Walker uses the predicted delays to determine how many machines should be deployed to operate at the worksite, for instance to account for predicted delays with material loading operations, material conveying operations, and/or material processing operations. Accordingly, the system described by Walker is focused on adjusting the number of machines operating at a worksite to account for predicted delays, instead of managing or directing real-time operations of such machines at the worksite.

### SUMMARY

In a first aspect of the present disclosure, a computer-implemented method includes receiving, by a fleet management controller, processing plant data from a plant management controller associated with a processing plant. The fleet management controller is configured to control first operations of a fleet of machines at a worksite to deliver loads of material to the processing plant. The plant management controller is configured to control second operations of the processing plant that process the loads of material delivered by the fleet of machines. The processing plant data is indicative of the second operations of the processing plant. The computer-implemented method also includes generating, by the fleet management controller, and based at least in part on the processing plant data, machine instructions that adjust the first operations of the fleet of machines in response to the second operations of the processing plant. The computer-implemented method further includes sending, by the fleet management controller, the machine instructions to the fleet of machines.

In a second aspect of the present disclosure, a fleet management controller includes a processor and a memory. The memory has stored thereon computer-executable instructions that when executed by the processor cause the processor to generate machine instructions that control first operations of a fleet of machines at a worksite, wherein the first operations cause the fleet of machines to deliver loads of material to a processing plant. The computer-executable instructions also cause the processor to receive processing plant data from a plant management controller that is configured to control second operations of the processing plant that process the loads of material delivered by the fleet of machines, wherein the processing plant data is indicative of the second operations of the processing plant. The computer-executable instructions additionally cause the processor to adjust the machine instructions, based at least in part on the processing plant data, to change the first operations of the fleet of machines in response to the second operations of the processing plant.

In a third aspect of the present disclosure, a worksite system includes a plurality of machines at a worksite, a fleet management controller associated with the plurality of machines, and a plant management controller associated with at least one processing plant configured to process material. Individual machines, of the plurality of machines, are configured to be loaded with the material at the worksite, and to deliver the material to one or more crushers associated with the at least one processing plant. The fleet management controller is configured to manage first operations of the plurality of machines at the worksite. The fleet management controller is also configured to provide first data, indicative of the first operations of the plurality of machines, to the plant management controller, and to receive second data, indicative of second operations of the at least one processing plant, from the plant management controller. The fleet management controller is further configured to generate, based at least in part on the second data, machine instructions that adjust the first operations of the plurality of machines in response to the second operations of the at least one processing plant, and to send the machine instructions to the plurality of machines. The plant management controller is configured to manage the second operations of the at least one processing plant. The plant management controller is also configured to provide the second data to the fleet management controller, and to receive the first data from the fleet management controller. The plant management is further configured to generate, based at least in part on the first data, plant instructions that adjust the second operations of the at least one processing plant in response to the first operations of the plurality of machines, and to send the plant instructions to the at least one processing plant.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is an exemplary diagrammatic illustration of a worksite at which machines deliver loads of material to one or more processing plants, in accordance with an embodiment of the present disclosure.

FIG. 2 is a flowchart illustrating an exemplary process for dynamically managing operations of machines at the worksite, based at least in part on processing plant data received from a plant management controller, in accordance with an embodiment of the present disclosure.

FIG. 3 is a flowchart illustrating an exemplary process for dynamically managing operations of elements of a processing plant, based at least in part, on material load data received from a fleet management controller, in accordance with an embodiment of the present disclosure.

FIG. 4 is a schematic illustration depicting an exemplary architecture of a computing system that executes one or more elements described in the present disclosure.

### DETAILED DESCRIPTION

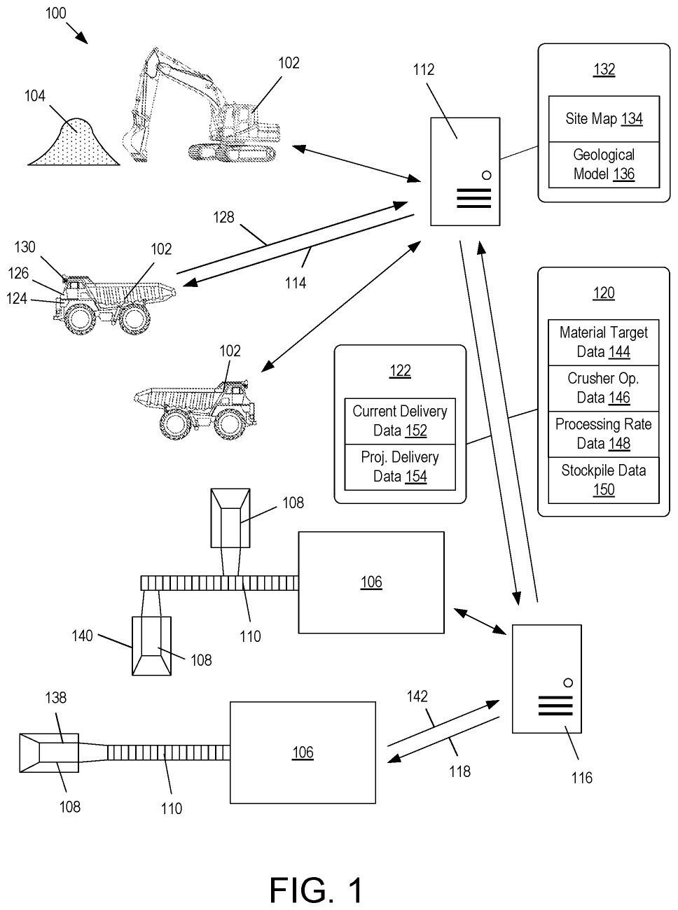

FIG. 1 is an exemplary diagrammatic illustration of a worksite 100 at which machines 102 deliver loads of material 104 to one or more processing plants 106, in accordance with an embodiment of the present disclosure. For example, the machines 102 can include haul trucks that deliver loads of material 104 to one or more crushers 108 associated with the processing plants 106. The crushers 108 can crush or otherwise process the material 104 delivered by the machines 102, and the crushed material 104 can be transported by conveyor belts 110 or other transportation mechanisms to other downstream elements of the processing plants 106 that are configured to further process the crushed material 104.

Operations of the machines 102 at the worksite 100 can be managed automatically by a fleet management controller 112. The fleet management controller 112 can generate machine instructions 114 for one or more machines 102, which may assign and/or instruct machines 102, or operators of the machines 102, to perform particular operations at the worksite 100. The machine instructions 114 can, for example, cause machines 102 to be loaded with material 104 at particular locations at the worksite 100, cause the machines 102 to deliver loads of material 104 to particular crushers 108, cause the machines 102 to traverse particular routes at the worksite 100, and/or cause the machines 102 to perform other operations at the worksite 100 as described further below.

Operations of the crushers 108, conveyor belts 110, and/or other elements of the processing plants 106 can be managed automatically by a plant management controller 116. The plant management controller 116 can generate plant instructions 118 for elements of the processing plants 106. For example, the plant instructions 118 can control which crushers 108 are active, control rates at which the crushers 108 crush material 104, control operations of rock breakers and/or other elements associated with the crushers 108, control operating speeds of the conveyor belts 110, control operations of downstream elements of the processing plants 106, and/or control other operations of the processing plants 106 as described further below.

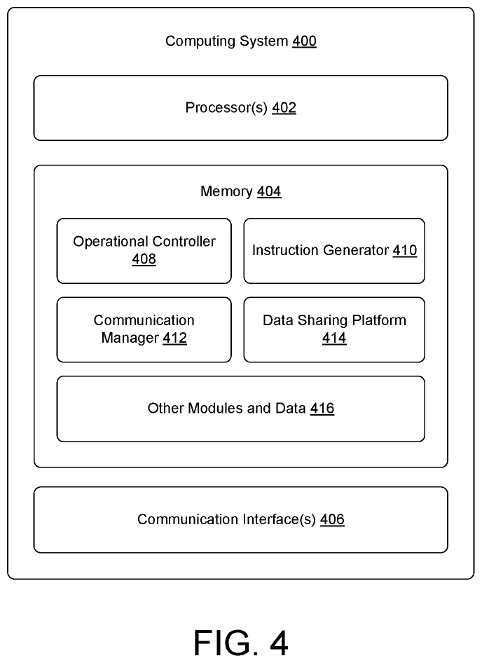

The fleet management controller 112 can be, or be executed by, one or more processors, servers, or other computing devices associated with the machines 102, such as a remote server or a server located at the worksite 100. The plant management controller 116 can similarly be, or be executed by, one or more processors, servers, or other computing devices associated with the one or more processing plants 106, such as a remote server or a server located at a processing plant. FIG. 4, discussed further below, shows an example system architecture for the fleet management controller 112 and/or the plant management controller 116. In some examples, the fleet management controller 112 and the plant management controller 116 can be elements of a worksite system that associated with the worksite 100, and/or the machines 102 and the processing plants 106 associated with the worksite 100.

As discussed further below, the fleet management controller 112 and the plant management controller 116 can communicate bidirectionally by exchanging data via one or more networks or data links. For example, the fleet management controller 112 can receive processing plant data 120, associated with operations of the processing plants 106, from the plant management controller 116. Similarly, the plant management controller 116 can receive material load data 122, including information about loads of material 104 that are being and/or will be delivered by machines 102 to the processing plants 106, from the fleet management controller 112. Accordingly, the fleet management controller 112 can generate machine instructions 114 to dynamically manage operations of machines 102 on the worksite 100 based at least in part on the processing plant data 120 received from the plant management controller 116, as described further below. The plant management controller 116 can also generate plant instructions 118 to dynamically manage operations of the processing plants 106 based at least in part on the material load data 122 received from the fleet management controller 112, as described further below.

The worksite 100 can be a mine site, a quarry, or any other type of worksite or work environment in which material 104 is to be transported to one or more processing plants 106. As an example, the worksite 100 may be an open-pit mine, an underground mine, a stope mining site, or any other type of mine site where material 104 may be excavated or obtained and then transported by machines 102 to one or more processing plants 106 for further processing. The material 104 can be ore, rocks, or other types of material that may be present at the worksite 100, and that can be excavated or otherwise obtained by one or more machines 102 at the worksite 100. The processing plants 106 can be configured to process the material 104, for instance to extract gold, copper, and/or other minerals from the material 104.

As an example, the material 104 can be ore that is excavated from locations at the worksite 100 by one or more machines 102. The excavated ore can be transported by one or more machines 102 to crushers 108 associated with the processing plants 106. The crushers 108 can crush the ore into smaller pieces, such that downstream elements of the processing plants 106 can process the crushed ore to extract metals and/or other minerals from the crushed ore.

The material 104 delivered by machines 102 to one or more crushers 108 can impact material blends at the one or more crushers 108. For instance, different machines 102 may deliver material 104 of different types, different grades, different material modifiers (such as wet or dry material), and/or other different attributes to a crusher, such that the crusher may have, or be processing, a cumulative blend of the varying material 104 that has been delivered to the crusher.

Multiple types of machines 102 can be present at the worksite 100, such as excavation machines, loading machines, hauling machines, and/or other types of stationary and/or mobile machines. For example, the machines 102 can include excavators, scrapers, loaders, and/or other types of machines that dig or otherwise obtain material 104 at the worksite 100, and/or that can load material 104 onto other machines 102. The machines 102 can also include haul trucks and/or other types of mobile machines that can be loaded with material 104, for instance by an excavator, loader, or other machine, and that can transport the material 104 to one or more crushers 108 associated with one or more processing plants 106.

The machines 102 can include trucks, vehicles, or other mobile machines that have engines, motors, drivetrains, braking systems, hydraulic components, and/or other mechanisms that cause movement of wheels or treads of the machines 102, movement of work tools and/or other elements of the machines 102, and/or otherwise implement operations of the machines 102. In some examples, one or more of the machines 102 can be fuel-powered machines that operate based on power provided by internal combustion engines and/or other elements that consume fuel. In other examples, one or more of the machines 102 can be battery electric machines (BEMs), battery electric vehicles (BEVs), hybrid vehicles, fuel cell and battery hybrid vehicles, or other mobile machines. For instance, the machines 102 can have batteries, such as lithium-ion (Li-ion) batteries, lithium-ion polymer batteries, nickel-metal hydride (NiMH) batteries, lead-acid batteries, nickel cadmium (Ni—Cd) batteries, zinc-air batteries, sodium-nickel chloride batteries, or other types of batteries that can at least partially power the machines 102.

The machines 102 can include manually operated machines, semi-autonomous machines, remotely-controlled machines, and/or autonomous machines. In examples in which a machine is a manually operated machine or a semi-autonomous machine, a human operator or driver can operate, control, or direct some or all of the functions of the machine, for instance in response to machine instructions 114 provided by the fleet management controller 112. In other examples in which a machine is autonomous, semi-autonomous, or remotely controlled, functions of the machine, such as steering, speed adjustments, work tool positioning and movement, and/or other functions can be fully or partially controlled, automatically or semi-automatically, by on-board and/or off-board controllers or other computing devices based on machine instructions 114 provided by the fleet management controller 112.

As an example, a machine can have an electronic control module (ECM) 124 or other on-board computing device including one or more on-board processors that can fully or partially control operations of the machine, for instance to cause the machine to perform operations based on machine instructions 114 from the fleet management controller 112. The machine can, for example, have an on-board guidance system that can drive the machine autonomously, an obstacle detection system that assists the on-board guidance system or can alert a human operator of nearby objects detected by the obstacle detection system, and/or other systems that fully or partially control operations of the machine to perform operations as directed by machine instructions 114 provided by the fleet management controller 112. As another example, the fleet management controller 112 or another off-board computing device can receive data from the machine and return machine instructions 114 to the ECM 124 of the machine, in order to fully or partially control operations of the machine remotely.

The machines 102 can each have one or more machine sensors 126. The machine sensors 126 can include cameras, LIDAR sensors, RADAR sensors, other optical sensors or perception systems, Global Positioning System (GPS) sensors, other location and/or positioning sensors, incline and decline travel sensors, speed sensors, work tool position sensors, temperature sensors, tire pressure sensors, battery state of health (SoH) sensors, fuel sensors, payload monitors, material type and/or grade sensors, material moisture level sensors, and/or other types of sensors.

Machine operational data 128 indicating attributes of the operations of a machine, and/or a load of material 104 carried by the machine, can be provided to the ECM 124 of the machine and/or the fleet management controller 112. The machine operational data 128 can include sensor data measured or determined by one or more machine sensors 126 of the machine, data derived from one or more types of sensor data, input from a human operator of the machine, and/or other types of data.

The ECM 124 and/or the fleet management controller 112 can use the machine operational data 128 to determine a location of the machine at the worksite 100, detect nearby terrain, detect nearby objects, such as vehicles, other machines, or personnel, detect the positions of such nearby objects relative to the machine, determine attributes of a payload of material 104 carried by the machine, determine a state of charge (SoC) of a battery system of the machine, determine an amount of fuel carried by the machine, and/or perform other operations. In some examples, as described further below, sensor data and/or input from human operators can indicate a weight of a load of material 104 carried by a machine, a material type of the load of material 104 carried by the machine, a material grade of the load of material 104 carried by the machine, fragment sizes of the load of material 104 carried by the machine, moisture content levels of the load of material 104 carried by the machine, and/or other attributes of the load of material 104 carried by the machine.

In some examples, sensor data and/or other types of machine operational data 128 can enable the ECM 124 of a machine to cause the machine to drive and/or operate autonomously or semi-autonomously, for instance to carry out machine instructions 114 from the fleet management controller 112. As another example, sensor data and/or other types of machine operational data 128 associated with a machine can be used by the fleet management controller 112 to determine a location of the machine, a travel speed of the machine, attributes of a payload of material 104 carried by the machine, and/or other data that the fleet management controller 112 can use to track movements of machines 102 and material 104, and/or to determine machine instructions 114 for the machine and/or other machines 102, as described herein.

The machines 102 can have wireless communication interfaces 130 that are operably coupled to ECMs and/or other on-board computing systems of the machines 102, and that allow the ECMs and/or other on-board computing systems of the machines 102 to exchange data with the fleet management controller 112. For example, the wireless communication interfaces 130 of the machines 102 can be used to transmit location data, sensor data, speed data, material payload data, and/or other types of machine operational data 128 to the fleet management controller 112, and/or to receive machine instructions 114 from the fleet management controller 112.

The wireless communication interfaces 130 can be, or include, cellular interfaces, modems, receivers, transmitters, antennas, and/or other hardware or software elements configured to send and receive data. The fleet management controller 112 can have, or be associated with, the same or similar types of wireless communication interfaces 130, such that the fleet management controller 112 can wirelessly exchange data with ECMs and/or other on-board computing systems of the machines 102. The fleet management controller 112 can also use wireless communication interfaces 130, or wired communication interfaces, to receive processing plant data 120 from the plant management controller 116 and to provide material load data 122 to the plant management controller 116 as described herein.

As discussed above, the machines 102 can operate at the worksite 100 based at least in part on machine instructions 114 generated and provided by the fleet management controller 112. For example, the fleet management controller 112 can send machine instructions 114 to individual machines 102 that assign the machines 102 to be loaded with material 104 at particular locations at the worksite 100, assign the machines 102 to deliver the loads of material to particular crushers 108, assign the machines 102 to travel between material loading areas and/or crushers 108 via particular inbound and/or outbound routes, assign the machines 102 to travel at particular speeds, assign the machines 102 to park and/or idle at particular locations at the worksite 100, assign the machines 102 to refuel or recharge batteries at particular locations at the worksite 100, and/or assign the machines 102 to perform other types operations at the worksite 100. The fleet management controller 112 can accordingly generate and send machine instructions 114 to dispatch and control machines 102 at the worksite 100.

In some examples, the machines 102 can be autonomous or semi-autonomous, and can automatically follow machine instructions 114 provided by the fleet management controller 112. In other examples in which machines 102 are staffed machines or are at least partially controlled by human operators, machine instructions 114 provided by the fleet management controller 112 can be displayed to the human operators via dashboard displays or other displays of the machines 102, or via tablet computers, smartphones, or other user devices associated with the human operators, such that the human operators can control the machines 102 to implement the machine instructions 114 provided by the fleet management controller 112.

The fleet management controller 112 may also have, or have access to, worksite data 132 that indicates attributes of the worksite 100. For example, the worksite data 132 may include a site map 134 of the worksite 100, a geological model 136 of the worksite 100, and/or other information about the worksite 100.

The site map 134 can indicate locations of boundaries of the worksite 100, terrain types and/or grades at the worksite 100, locations of defined routes or paths at the worksite 100 that can be traversed by machines 102, locations of machines 102 at the worksite 100, locations of crushers 108 and/or other elements of the processing plants 106 at the worksite 100, locations of fueling stations and/or battery charging stations at the worksite 100, locations and/or identities of obstacles at the worksite 100, and/or other information associated with the worksite 100. The fleet management controller 112 may use machine operational data 128 associated with individual machines 102 to update the site map 134 over time, for instance to update information indicating locations of individual machines 102. The fleet management controller 112 can also use the site map 134 to generate machine instructions 114, for instance to dispatch machines 102 to travel between locations indicated by the site map 134 and/or along routes indicated by the site map 134.

The geological model 136 of the worksite 100 can indicate types of material 104, grades of material 104, and/or other attributes of material 104 that are expected to be present at one or more locations at the worksite 100, for instance based on surveys, inspections, exploratory drilling, and/or other analyses of the worksite 100. Accordingly, when material 104 is excavated from a particular location at the worksite 100, the geological model 136 can indicate expected attributes of the material 104 excavated from that location, such as type of the material 104, a grade of the material 104, a moisture content level of the material 104, and/or other attributes of the material 104. In some examples, the geological model 136 can be generated and/or provided by an owner or operator of the fleet management controller 112. In other examples, the geological model 136 can be generated and/or provided by another entity, such as an owner of the worksite 100 or a customer who will receive the material 104 after processing of the material 104 by the processing plants 106. In some of these examples, the fleet management controller 112 can use an application programing interface (API) or other system to access or query the geological model 136, for instance via a separate computing system or platform, to determine expected attributes of material 104 present at locations at the worksite 100.

The fleet management controller 112 can generate the machine instructions 114 associated with individual machines 102 based on machine operational data 128 received from those machines 102, based on machine operational data 128 received from other machines 102, based on worksite data 132, and/or based on other data associated with operations at the worksite 100 as described above. However, the fleet management controller 112 can also generate machine instructions 114 for individual machines 102 based at least in part on processing plant data 120 received from the plant management controller 116, as described further below. Accordingly, the fleet management controller 112 can dynamically control operations of one or more machines 102 at the worksite 100 in response to, and/or based on, operations of one or more elements of the processing plants 106 indicated by the processing plant data 120. The fleet management controller 112 can also use the machine operational data 128, worksite data 132, and/or other data to generate material load data 122, and can provide the material load data 122 to the plant management controller 116 as discussed further below.

The plant management controller 116 can be, or be executed by, one or more processors, servers, or other computing systems that are configured to manage or direct operations of one or more processing plants 106. Processors, servers, other computing systems, and/or software elements associated with the plant management controller 116 can, in some examples, be separate and/or distinct from processors, servers, other computing systems, and/or software elements that are associated with the fleet management controller 112. However, as described herein, the plant management controller 116 can be configured to communicate bidirectionally with the fleet management controller 112, such that the plant management controller 116 provides processing plant data 120 to the fleet management controller 112 and receives material load data 122 from the fleet management controller 112. The plant management controller 116 can accordingly dynamically manage operations of the processing plants 106 based at least in part on, and/or in response to, the material load data 122 received from the fleet management controller 112. The fleet management controller 112 can also dynamically manage operations of the machines 102 at the worksite 100 based at least in part on, and/or in response to, the processing plant data 120 received from the plant management controller 116.

In some examples, the same plant management controller 116 may manage operations of different processing plants 106. In other examples, different plant management controllers may manage operations of different processing plants 106, and may each communicate with the fleet management controller 112 as described herein by providing processing plant data 120 to the fleet management controller 112 and receiving material load data 122 from the fleet management controller 112. Additionally, although multiple processing plants 106 are shown in FIG. 1, in some examples a single processing plant may be at or near the worksite 100.

As discussed above, material 104 excavated or otherwise obtained at the worksite 100 can be delivered by machines 102 to the processing plants 106. Each processing plant may be associated with one or more crushers 108 that are configured to crush delivered material 104 into smaller pieces. For example, one processing plant may be associated with a single crusher that feeds crushed material 104 into other downstream elements of the processing plant, while another processing plant may be associated with multiple crushers 108 that feed crushed material 104 into other downstream elements of the processing plant.

Individual crushers 108 can have bins, into which one or more machines 102 can dump material 104. Material 104 added to the bin of a crusher can be crushed into smaller pieces by the crusher. The crushed material 104 can be deposited by the crusher onto a conveyor belt to be transported to other elements of the processing plant, or into a stockpile or other temporary storage location.

Crushers 108 may also have, or be associated with, rock breakers 138 that are configured to break down larger pieces of material 104 into pieces of material 104 that can be further crushed by the crushers 108. For example, if pieces of material 104 in the bin of a crusher are too large to be crushed normally by a crusher, a rock breaker associated with the crusher can be activated to break the large pieces of material 104 into smaller pieces that can be crushed normally by the crusher.

Individual processing plants 106 may also have one or more conveyor belts 110 or other transportation mechanisms that transport crushed material to other elements of the processing plants 106. In some examples, a single crusher may deposit crusher material onto a conveyor belt. In other examples, multiple crushers 108 may deposit crushed material 104 onto the same conveyor belt.

In some examples, a processing plant may also have a course ore stockpile (COS) and/or other stockpiles of material 104 (not shown). During times at which corresponding crushers 108 are not operating or are not feeding crushed material 104 to downstream elements of the processing plant, the downstream elements of the processing plant can process material 104 from the COS and/or other stockpiles of material 104. For example, conveyor belts 110 or other transportation mechanisms can transport material 104 from the COS and/or other stockpiles to be processed by other elements of the processing plant.

A processing plant can have one or more plant sensors 140 that measure and/or determine sensor data associated with operations of elements of the processing plant. The plant sensors 140 can include bin sensors associated with crushers 108 that are configured to measure how much material 104 is in the bins of the crushers 108, and/or how full the bins are relative to maximum capacities of the bins. The plant sensors 140 can also include rate sensors configured to measure how quickly crushers 108 are crushing material 104. The plant sensors 140 can also include sensors that measure speeds of conveyor belts 110, sensors that measure how much material 104 is in stockpiles and is available to be processed by the processing plant, and/or other types of sensors that measure or determine attributes of operations of the processing plants 106.

Operations of elements of one or more processing plants 106 can be automatically managed by the plant management controller 116. Plant operational data 142 indicating attributes of the operations the processing plants 106 can be provided to the plant management controller 116 via wired and/or wireless networks. The plant operational data 142 can include sensor data measured or determined by one or more plant sensors 140, data derived from such sensor data, input from human workers at the processing plants 106, and/or other types of data.

As discussed above, elements of the processing plants 106 can operate based at least in part on plant instructions 118 generated and provided by the plant management controller 116. For example, the plant management controller 116 can send plant instructions 118 that cause individual crushers 108 to turn on or off, adjust rates at which individual crushers 108 crush material 104, instruct rock breakers 138 associated with individual crushers 108 to activate or deactivate, adjust speeds at which conveyor belts 110 transport material 104 from the crushers 108 and/or stockpiles to downstream elements of the processing plants 106, control operations of downstream elements of the processing plants 106 that are configured to extract minerals from the material 104, and/or otherwise control operations of the processing plants 106.

The plant management controller 116 can have or be associated with wireless communication interfaces, similar to wireless communication interfaces 130 discussed above, and/or wired communication interfaces. The plant management controller 116 can use such wireless and/or wired communication interfaces to receive plant operational data 142, and to send plant instructions. The plant management controller 116 can use such wireless and/or wired communication interfaces to communicate bidirectionally with the fleet management controller 112 as described herein.

The plant management controller 116 can generate plant instructions 118 based on the plant operational data 142 indicating attributes of operations of the processing plants 106. For example, based on plant operational data 142 associated with current operations of a crusher, the plant management controller 116 may generate and send new plant instructions 118 that adjust the operations of the crusher. However, the plant management controller 116 can also generate plant instructions 118 for individual elements of one or more processing plants 106 based at least in part on material load data 122 received from the plant management controller 116, as described further below. Accordingly, the plant management controller 116 can dynamically control operations of elements of processing plants 106 in response to, and/or based on, operations of machines 102 and/or information about loads of material 104 transported by the machines 102 indicated by the material load data 122. The plant management controller 116 can also use the plant operational data 142 and/or other data to generate processing plant data 120, and can provide the processing plant data 120 to the fleet management controller 112 as discussed further below.

The fleet management controller 112 and the plant management controller 116 can exchange the processing plant data 120 and the material load data 122 via one or more networks or other data links, for instance via wired and/or wired communication interfaces. In some examples, the processing plant data 120 and the material load data 122 can be exchanged via one or more APIs, data sharing platforms, or other systems associated with the fleet management controller 112 and/or the plant management controller 116. As an example, the fleet management controller 112 may provide a data storage location and/or an API that allows the fleet management controller 112 to publish material load data 122, such that the material load data 122 can be accessed and/or retrieved by the plant management controller 116. Similarly, the data storage location and/or the API can allow the plant management controller 116 to publish processing plant data 120, such that the processing plant data 120 can be accessed and/or retrieved by the fleet management controller 112. As another example, the fleet management controller 112 and the plant management controller 116 can have messaging elements that send and receive data messages to exchange the processing plant data 120 and the material load data 122.

In some examples, the fleet management controller 112 and the plant management controller 116 can exchange processing plant data 120 and the material load data 122 continuously, for instance substantially in real-time as processing plant data 120 and/or material load data 122 is determined or updated based on respective operations of the processing plants 106 and the machines 102. In other examples, the fleet management controller 112 and the plant management controller 116 can exchange processing plant data 120 and the material load data 122 periodically or occasionally, for instance at preset intervals or based on predetermined schedules.

As discussed above, the processing plant data 120 can indicate information associated with operations of crushers 108, conveyor belts 110, rock breakers 138, and/or other elements of the processing plants 106. For example, the processing plant data 120 can include material target data 144, crusher operational data 146, material processing rate data 148, stockpile data 150, and/or other types of data as described further below. In some examples, one or more types of the processing plant data 120 can be based on plant operational data 142, such as sensor data captured by plant sensors 140. The plant management controller 116 can provide the processing plant data 120 to the fleet management controller 112, such that the fleet management controller 112 can dynamically generate machine instructions 114 for one or more machines 102 based at least in part on the processing plant data 120.

The material target data 144 can indicate target attributes of material 104 that is to be delivered to one or more crushers 108. For example, the material target data 144 can indicate particular types, grades, and/or blends of material 104, particular amounts of material 104, and/or other attributes of material 104 to be delivered to crushers 108. In some examples, the material target data 144 may also include material modifier data indicating sizes of material 104 that can be accepted or processed by crushers 108, moisture content levels of material 104 that can be accepted or processed by crushers 108, and/or other modifier data that may impact whether or not crushers 108 can accept or process material 104.

The fleet management controller 112 can generate machine instructions 114 based on the material target data 144. As an example, machine operational data 128 and/or the geological model 136 may indicate attributes of a load of material 104 that has been loaded onto a machine, such as a material type, a material grade, fragment size information moisture content level information, and/or other information about the load of material 104. The fleet management controller 112 may use the material target data 144 provided by the plant management controller 116 to determine that a particular crusher is currently accepting and/or processing material 104 with attributes that correspond with the attributes of the material 104 that was loaded onto the machine. Accordingly, the fleet management controller 112 may issue machine instructions 114 that cause the machine to travel to, and to deliver the load of material 104 to, that particular crusher instead of other crushers that are not currently accepting and/or processing material 104 with those attributes.

The material target data 144 may change over time, and the fleet management controller 112 can dynamically adjust operations of machines 102 in response to changes in the material target data 144. For example, at a first time, the material target data 144 may indicate that a particular crusher is accepting material 104 with a relatively high moisture content level, such that the fleet management controller 112 may cause machines 102 to deliver loads of material 104 that have relatively high moisture content levels to that particular crusher. However, at a second time, the material target data 144 may indicate that the particular crusher is accepting material with a lower moisture content level and is no longer accepting material 104 with a relatively high moisture content level. The fleet management controller 112 may accordingly change operations of the machines 102 to cause deliveries of loads of material 104 that have lower moisture content levels to that particular crusher.

The crusher operational data 146 can include information about current and/or future operations of individual crushers 108. For instance, the crusher operational data 146 can indicate whether crushers 108 are currently active, whether crushers 108 are currently down for maintenance, planned times at which offline crushers 108 are expected to come online, fullness levels of bins of crushers 108, whether crushers 108 are associated with open indicators signifying that the crushers 108 are currently able to accept loads of material 104, whether crushers 108 are associated with closed indicators signifying that the crushers 108 are online but are not currently able to accept material 104, whether rock breakers 138 associated with crushers 108 are active, planned times at which rock breakers 138 associated with crushers 108 are expected to be activated, and/or other information about current and/or future operations of the crushers 108.

The fleet management controller 112 can generate machine instructions 114 based on the crusher operational data 146, for instance to cause one or more machines 102 to perform operations at the worksite 100 based on current and/or future operations of one or more crushers 108. The machine instructions 114 may be new instructions for one or more machines 102, or modify previous instructions for one or more machines 102, such that the fleet management controller 112 can dynamically adjust operations of machines 102 in response to the crusher operational data 146.

As a first example, the crusher operational data 146 may indicate that a particular crusher has gone offline for maintenance. In this example, the fleet management controller 112 can avoid issuing machine instructions 114 that cause machines 102 to deliver loads of material 104 to the particular crusher while the crusher is offline. The fleet management controller 112 may instead issue machine instructions 114 that cause machines 102 to transport loads of material 104 to one or more other crushers 108 that, according to the crusher operational data 146, are online and are able to accept the loads of material 104. Similarly, if a machine had previously been instructed to transport a load of material 104 to the particular crusher that is now offline, and the machine is currently loaded with material 104 and is en route to the particular crusher, the fleet management controller 112 may issue machine instructions 114 that adjust operations of the machine and that cause the machine to instead deliver the load of material 104 to a different crusher. In some examples, the fleet management controller 112 may also, or alternately, issue machine instructions 114 that cause one or more machines 102 to park and/or cease operations, travel to refueling or battery recharging stations, or perform other non-delivery operations during periods of time when crusher operational data 146 indicates that one or more crushers 108 are offline.

As a second example, the crusher operational data 146 may indicate that a particular crusher is currently offline, but is planned to come online at a particular time in the future. Accordingly, based on the expected time at which the crusher will come online, the fleet management controller 112 can issue machine instructions 114 that cause a machine to be loaded with material 104 before the expected time at which the crusher will come online, and that cause the machine to travel to the crusher such that the machine arrives at the crusher with the load of material 104 at or around the time at which the crusher comes online. Accordingly, the fleet management controller 112 can cause loads of material 104 to be delivered to the crusher by machines 102 substantially immediately after the crusher comes online, instead of waiting to begin loading machines 102 and dispatching the machines 102 to travel to the crusher after the crusher comes online, which can thereby reduce or minimize periods of time when the crusher is online but is not accepting or crushing material 104.

As a third example, the crusher operational data 146 may indicate open indicators and closed indicators associated with crushers 108, and/or bin fullness levels and thresholds that are used to determine open indicators and closed indicators associated with the crushers 108. In some examples, open indicators may be known as “green light” signals or indicators, while closed indicators may be known as “red light” signals or indicators. A crusher may be associated with an open indicator when the bin of the crusher has a fullness level below a threshold, such that the bin can accept loads of material 104 from one or more machines 102. However, a crusher may be associated with a closed indicator when the bin of the crusher has a fullness level that is at or above the threshold, such the bin cannot accept loads of material 104 from one or more machines 102 until the crusher has crushed enough material from the bin to drop the fullness level of the bin to below the threshold.

Accordingly, if the crusher operational data 146 indicates that a particular crusher is associated with a closed indicator, such as a “red light” signal, the fleet management controller 112 can avoid issuing machine instructions 114 that cause machines 102 to deliver loads of material 104 to the particular crusher while the crusher is associated with the closed indicator. The fleet management controller 112 may instead issue machine instructions 114 that cause machines 102 to transport loads of material 104 to one or more other crushers 108 that, according to the crusher operational data 146, are online and have open indicators, such as “green light” signals. Similarly, if a machine had previously been instructed to transport a load of material 104 to the particular crusher that is now associated with a closed indicator, and the machine is currently loaded with material 104 and is en route to the particular crusher, the fleet management controller 112 may issue machine instructions 114 that adjust operations of the machine and cause the machine to instead deliver the load of material 104 to a different crusher that may be associated with an open indicator. In some examples, the fleet management controller 112 may also, or alternately, issue machine instructions 114 that cause one or more machines 102 to park and/or cease operations, travel to refueling or battery recharging stations, or perform other non-delivery operations during periods of time when crusher operational data 146 indicates that one or more crushers 108 are offline, or are online but are associated with closed indicators signifying that the crushers 108 are currently unable to accept more material 104.

If the crusher operational data 146 indicates that a particular crusher is currently associated with a closed indicator, but will change to being associated with an open indicator at a future time, the fleet management controller 112 can issue machine instructions 114 that cause a machine to be loaded with material 104 before the expected time at which the open indicator will begin, and/or that cause the machine to travel to the crusher such that the machine arrives at the crusher with the load of material 104 at or around the time at which the open indicator associated with the crusher begins. Accordingly, the fleet management controller 112 can cause loads of material 104 to be delivered to the crusher by machines 102 substantially immediately after the crusher changes from being associated with a closed indicator to being associated with an open indicator, instead of waiting to begin loading machines 102 and dispatching the machines 102 to travel to the crusher after the crusher changes to being associated with an open indicator, which can thereby reduce or minimize periods of time when the crusher is associated with an open indicator but is not accepting or crushing material 104.

In some examples the crusher operational data 146 may indicate current fullness levels of bins of crushers, as well as threshold fullness levels associated with open indicators or closed indicators. Accordingly, the crusher operational data 146 may allow the fleet management controller 112 to determine whether a load of material 104 being transported by a machine to a crusher is likely to cause the fullness level of the bin of the crusher to exceed the threshold fullness level and thereby cause a closed indicator associated with the crusher. If the crusher operational data 146 indicates that a load of material 104 that a machine will be delivering to a particular crusher will cause the particular crusher to become associated with a closed indicator for a period of time, the fleet management controller 112 may issue machine instructions 114 that divert other loaded machines 102 to other crushers 108, instead of having the loaded machines 102 queue outside the particular crusher while the particular crusher is associated with the closed indicator.

The fleet management controller 112 may also determine, based on tracking crusher operational data 146 over a period of time, times between when crushers 108 become associated with closed indicators after deliveries of loads of material 104, and when the crushers 108 again become associated with open indicators. Such times may be impacted by attributes of the loads of material 104 delivered by machines 102. For instance, it may take longer on average for a crusher to return to being associated with an open indicator after delivery of wet material 104, than for the crusher to return to being associated with an open indicator after delivery of dry material 104. Accordingly, the fleet management controller 112 may generate machine instructions 114 that cause machines 102 to avoid delivering material 104 to crushers 108 during times at which the crushers 108 are likely to still be associated with closed indicators after preceding deliveries of material 104, and/or to deliver material 104 to the crushers 108 at times at which the crushers 108 are likely to return to being associated with open indicators after preceding deliveries of material 104.

As a fourth example, the crusher operational data 146 can indicate current and/or future operational statuses associated with rock breakers 138 associated with crushers 108, such as operational statuses indicating whether rock breakers 138 are currently active and/or when rock breakers 138 will be active in the future. Machines 102 may be able to deliver loads of material 104 to crushers 108 while the crushers 108 are operating normally and are associated with open indicators, for instance by dumping the loads of material 104 into bins of the crushers 108 even while material 104 from the bins is being crushed by the crushers 108. However, it may not be safe for machines 102 to be at or near the crushers 108 when rock breakers 138 associated with the crushers 108 are active. Accordingly, if the crusher operational data 146 indicates that a rock crusher associated with a particular crusher is planned to be activated at a particular time, the fleet management controller 112 can issue machine instructions 114 that cause machines 102 to be at least a safe threshold distance away from that crusher at the planned time when the rock breaker will be activated. For instance, the fleet management controller 112 can issue machine instructions 114 that cause machines 102 to finish delivering loads of material 104 to the crusher before the planned time at which the rock breaker will be activated, or to park, idle, refuel, recharge, deliver loads of material 104 to other crushers 108, or perform other operations if the machines 102 would be unable to complete deliveries of material 104 to the crusher before the planned time at which the rock breaker will be activated.

The material processing rate data 148 can include information about rates at which one or more crushers 108, and/or other elements of the processing plants 106 can, are, and/or have been processing material 104 delivered by machines 102 to the crushers 108. As an example, the material processing rate data 148 can indicate that a particular crusher has been processing a particular amount of material 104 per hour. The material processing rate data 148 can also indicate changes in processing rates over time. As non-limiting example, the material processing rate data 148 can indicate that a particular crusher has been processing 10% less material during the last hour, relative to a processing rate associated with a previous period of time.

In some examples, the material processing rate data 148 can indicate different processing rates, and/or changes in such processing rates over time, associated with different types of materials, different grades of materials, different moisture levels of materials, different sizes of materials, and/or other material attributes. For instance, the material processing rate data 148 can indicate that relatively dry material 104 is processed by elements of a processing plant at a relatively high rate, but that relatively wet material 104 is processed more slowly by the same or different elements of the processing plant.

The fleet management controller 112 can generate machine instructions 114 based on the material processing rate data 148, for instance to cause machines 102 to deliver material 104 to crushers 108 at rates that correspond with maximum and/or current rates at which the crushers 108 and/or other elements of the processing plants 106 can process the delivered material. As a non-limiting example, if the fleet of machines 102 managed by the fleet management controller 112 has a capacity of delivering 10,000 tons of material 104 per hour to a processing plant, but the material processing rate data 148 provided by the plant management controller 116 indicates that the processing plant can only process 5,000 tons of material 104 per hour, the fleet management controller 112 may only dispatch half the number of machines 102 available at the worksite 100 to deliver material 104 to the processing plant, or may otherwise adjust operations of the machines 102 to cause only 5,000 tons of material 104 to be delivered by the machines 102 to the processing plant per hour. As another non-limiting example, if the material processing rate data 148 indicates that crushers 108 have been processing 10% less material over the last hour than an average processing rate, the fleet management controller 112 may issue machine instructions 114 that adjust operations of the machines 102 to transport and deliver 10% less material to the crushers 108 until the processing rate of the crushers 108 changes.

As yet another example, the material processing rate data 148 may indicate that elements of a processing plant generally process large and/or wet material 104 more slowly than smaller and/or drier material 104. Accordingly, if machine operational data 128 and/or the geological model 136 indicates that excavated material 104 is small and dry, the fleet management controller 112 may issue machine instructions 114 that cause one or more machines 102 to deliver the excavated material 104 to the processing plant at a relatively high delivery rate based on a corresponding processing rate indicated by the material processing rate data 148. However, if the machine operational data 128 and/or the geological model 136 indicates that excavated material 104 is bigger and/or wetter, the fleet management controller 112 may issue machine instructions 114 that cause one or more machines 102 to deliver the excavated material 104 to the processing plant at a lower delivery rate based on a corresponding processing rate indicated by the material processing rate data 148. For instance, the fleet management controller 112 may lower the delivery rate by dispatching fewer machines 102 to transport the excavated material 104 to the processing plant, and/or dispatch machines 102 to transport the excavated material 104 to the processing plan at times that are spaced apart by longer intervals.

In some examples, the fleet management controller 112 may also adjust operations of one or more machines 102 in an attempt to cause changes to the material processing rate data 148. As a non-limiting example, the fleet management controller 112 may have been dispatching machines 102 to deliver loads of wet material 104, with higher-than-average moisture content levels, to a particular crusher. However, changes in corresponding material processing rate data 148 may indicate that the processing of the wet material 104 has caused the crusher to process the material 104 at a processing rate that is 20% slower than an average processing rate. Accordingly, the fleet management controller 112 can adjust operations of machines 102 in response to the drop in the processing rate of the crusher, for instance by assigning machines 102 to deliver loads of drier material 104 to the crusher. Delivering drier material 104 to the crusher may allow the crusher to process the delivered material 104 more quickly, and thus increase a material processing rate indicated by the material processing rate data 148.

The stockpile data 150 can indicate amounts, types, and/or other attributes of material 104 present in stockpiles, if any, that are available to be processed by downstream elements of processing plants 106. The fleet management controller 112 can generate machine instructions 114 based on the stockpile data 150. As an example, if the stockpile data 150 indicates that a first processing plant has a COS with a significant amount of material 104, and a second processing plant does not have a COS, the fleet management controller 112 may prioritize dispatching machines 102 to deliver material 104 to the second processing plant. Accordingly, the second processing plant may process the material 104 delivered by the machines 102, while the first processing plant can process material 104 from the COS if machines 102 have not recently delivered material 104 to the first processing plant, thereby allowing both processing plants 106 to be productive in processing material 104.

The fleet management controller 112 can also generate machine instructions 114 associated with one or more machines 102 based on combinations of different types of processing plant data 120. For example, the material target data 144 may indicate a target amount of material 104 to be delivered to a processing plant per day. However, if crusher operational data 146 indicates that one or more crushers 108 associated with the processing plant will be offline for planned maintenance during a period of time, the fleet management controller 112 may adjust operations of machines 102 to increase a material delivery rate before and/or after the planned maintenance of the crushers 108, to offset a drop in the material delivery rate that may occur during the planned maintenance and to allow the total amount of material delivered during the day to meet the target amount of material. Similarly, if the crusher operational data 146 indicates that a particular crusher has gone offline, the fleet management controller 112 may adjust operations of machines 102 to increase a material delivery rate to other crushers 108 while the particular crusher is offline, and/or to the particular crusher after the particular crusher comes back online, to make up for an amount of material 104 that could not be delivered to the crusher particular while the crusher particular was offline.

As another example, the stockpile data 150 may indicate that a COS associated with a crusher at a processing plant is full, and the crusher operational data 146 indicates a closed indicator because a bin of the crusher that feeds into the COS is also fuller than a threshold level. In this example, the fleet management controller 112 may determine that an open indicator associated with the crusher is not imminent, because it will take time for material 104 to be moved from the COS, and for the bin of the crusher to then empty into the COS enough to drop the fullness level of the bin to below the threshold level. Accordingly, the fleet management controller 112 can prioritize dispatching machines 102 to deliver material 104 to other crushers or processing plants, or to perform other operations, until a time closer to when the stockpile data 150 and/or the crusher operational data 146 indicates that the crusher may become associated with an open indicator.

Overall, the fleet management controller 112 can dynamically adjust operations of one or more machines 102 at the worksite 100 based on one or more types of processing plant data 120 received from the plant management controller 116. The fleet management controller 112 can also provide one or more types of material load data 122 to the plant management controller 116, such that the plant management controller 116 can dynamically adjust operations of elements of one or more processing plants 106 based on the material load data 122 received from the fleet management controller 112.

The material load data 122 can indicate information associated with loads of material 104 that are being, and/or will be, transported by machines 102 to crushers 108. For example, the material load data 122 can include current delivery data 152 associated with loads of material 104 that are currently being transported by machines 102 to crushers 108. The material load data 122 can also include projected delivery data 154 associated with loads of material 104 that are planned or projected to be delivered to crushers 108 by machines 102 during a future period of time.

The current delivery data 152 can indicate which machines 102 are en route to crushers 108, how many machines 102 are en route to crushers 108, identities or locations of the crushers 108 to which the machines 102 will be delivering material 104, estimated times of arrival of the machines 102 at the crushers 108, and/or any other information about machines 102 that are en route to crushers 108. The current delivery data 152 can be determined by the fleet management controller 112 based on machine instructions 114 that have been generated and/or sent to machines 102, for instance to dispatch the machines 102 to be loaded with material 104, to travel via certain routes and/or at certain speeds, and/or to deliver the material to particular crushers 108. The current delivery data 152 may also be determined by the fleet management controller 112 based on machine operational data 128 that indicates current locations of the machines 102 at the worksite 100, current travel speeds of the machines 102, and/or other information the fleet management controller 112 can use to derive or estimate times at which the machines 102 will arrive at the crushers 108 to deliver the loads of material 104 being carried by the machines 102.

The current delivery data 152 can additionally indicate attributes of loads of material 104 that are being transported by machines 102 that are en route to the crushers 108, and that will be delivered to the crushers 108. For example, the current delivery data 152 can indicate attributes of a load of material 104 that a particular machine is transporting and will be delivering to a particular crusher, such as a weight and/or amount of the load of material 104, material type and/or material grade information associated with the load of material 104, fragment size data associated with load of material 104, moisture content level information associated with the load of material 104, and/or any other attributes of the load of material 104 that the particular machine will be delivering to the particular crusher.

The current delivery data 152 associated with a load of material 104 being transported by a machine to a crusher can be based on sensor data from machine sensors 126 of the machine, input from a human operator of the machine or another worker, the geological model 136, and/or other data. For example, the machine sensors 126 may include sensors that can measure or otherwise detect a weight and/or amount of material 104 that is loaded onto a machine, one or more material types of the material 104 loaded onto the machine, one or more grades of the material 104 loaded onto the machine, sizes of fragments of the material 104 loaded onto the machine, a moisture content level of the material 104 loaded onto the machine, and/or other attributes of the material 104 loaded onto the machine. Accordingly, sensor data provided by the machine sensors 126 can indicate attributes of a load of material 104 being transported by a machine. The sensor data, and/or the attributes of the load of material 104, can be included in machine operational data 128 sent to the fleet management controller 112, such that the fleet management controller 112 can indicate the attributes of the load of material 104 in corresponding current delivery data 152 provided to the plant management controller 116.

In some examples, a human operator of the machine and/or other workers may make observations about attributes of the material 104 loaded onto the machine, such as observations about the type, grade, size, and/or moisture content level of the material 104. Input about such observations can be provided via user devices, dashboard controls of the machine, and/or other interfaces to the fleet management controller 112, which can use the input to modify and/or augment the current delivery data 152 associated with the load of material 104. For instance, if a machine does not have a sensor configured to detect a moisture content level of material 104 loaded onto the machine, but a human operator observes that the material 104 loaded onto the machine is relatively wet, the fleet management controller 112 can use input about the moisture content of the material 104 provided by the human operator to add moisture content information to the current delivery data 152 associated with the load of material 104.

As another example, the geological model 136 may indicate expected types of material 104, expected grades of material 104, expected moisture content levels of material 104, and/or other expected attributes of material 104 at the worksite 100. Accordingly, when material 104 is excavated from a location at the worksite 100 and is loaded onto a machine for transport to a crusher, the fleet management controller 112 can use the geological model 136 to determine the expected attributes of that load of material 104, and can indicate the expected attributes in corresponding current delivery data 152.

In some examples, the fleet management controller 112 can use expected attributes of material 104 indicated by the geological model 136 as baseline attributes for a load of a material 104 to be indicated in corresponding current delivery data 152. However, the fleet management controller 112 may modify and/or augment the baseline attributes indicated by the geological model 136 based on input from one or more humans and/or sensor data provided by machine sensors 126. As an example, the geological model 136 may indicate that a particular type and grade of material 104 is expected to be found at a location at the worksite 100. However, when material 104 is actually excavated at that location and is loaded onto a machine, sensor data and/or human input may indicate that the excavated material 104 loaded onto the machine is of the expected type indicated by the geological model 136, but is of a different grade than was expected based on the geological model 136. Accordingly, the fleet management controller 112 can use the sensor data and/or human input to update the current delivery data 152 associated with the material 104 loaded onto the machine, to indicate the load of material carried by the machine is of an expected type, but is of a different-than-expected grade.

The plant management controller 116 can generate plant instructions 118 based on the current delivery data 152. For example, if the current delivery data 152 indicates that a particular amount of material 104 is en route to a particular crusher and will be delivered to the particular crusher by a machine at a particular time, the plant management controller 116 may generate plant instructions 118 that cause the particular crusher to perform crushing operations to lower a fullness level of a bin, in order to make room in the bin for the amount of material that will be delivered at the particular time according to the current delivery data 152.

As another example, the current delivery data 152 may indicate that no machines are present at, or are en route to, a crusher. For instance, the current delivery data 152 may indicate that zero machines 102 are currently en route to the crusher, that one or more machines 102 have broken down or are otherwise offline such that no machines 102 are currently available to travel to the crusher, or that routes through the worksite 100 to the crusher are currently impassible by machines 102. The plant management controller 116 may respond by generating plant instructions 118 that adjust operations of the crusher or other elements of a processing plant during a period of time when zero machines 102 are expected, based on the current delivery data 152, to be at or near the crusher. For instance, the plant management controller 116 may issue plant instructions 118 that, during the period of time when zero machines 102 are expected to arrive at the crusher, cause a rock breaker associated with the crusher to operate, cause a deactivation of the crusher or other downstream elements, cause an increase or decrease processing rates of the crusher or other elements of the processing plant, and/or or otherwise adjust operations of the crusher or other elements of the processing plant.

As yet another example, the current delivery data 152 may indicate that a load of material 104 of a particular material type, grade, size, and/or moisture content level is en route to a crusher. Accordingly, the plant management controller 116 can generate plant instructions 118 to adjust a processing rate and/or other operations of the crusher in advance of the delivery of the load of material 104, for instance to prepare the crusher to process material 104 of the particular material type, grade, size, and/or moisture content level indicated by the current delivery data 152. For instance, if the current delivery data 152 indicates that material that is en route to a crusher is wetter and/or larger than average, the plant management controller 116 may issue plant instructions 118 that may slow speeds at which the crusher process the material, to account for the wetter and/or larger attributes of the material 104.

The projected delivery data 154 can be similar to the current delivery data 152, but indicate information associated with planned or projected future loads of material 104 that will be transported by machines 102 to processing plants 106 over the next hour, two hours, three hours, or any other future period of time. For example, while the current delivery data 152 may indicate that a machine is currently transporting a particular load of material to a particular crusher, so that the plant management controller 116 may adjust operations of the crusher to prepare for delivery of the load of material, the projected delivery data 154 may indicate that ten loads of material 104 are expected to be delivered to the particular crusher over the next hour.

In some examples, the projected delivery data 154 can be based on future production schedules and/or plans associated with the worksite 100. For example, a plan for a workday may indicate how many machines 102 are planned to be operating during that workday, locations where material 104 is planned to be excavated during the workday, types of material 104 that are planned to be excavated and/or transported during the workday, and/or other information about planned operations of the machines 102 during the workday.

The fleet management controller 112 may also generate one or more types of projected delivery data 154 using rules-based models, machine learning models, other predictive models, and/or other systems that are configured to project, based on current and/or historical data, which machines 102 are likely to be dispatched to transport loads of material 104 to crushers 108, attributes of the loads of material 104 that are likely to be transported by the machines 102, and/or other attributes of likely future operations of the machines 102 at the worksite 100. For example, machine operational data 128, worksite data 132, issued machine instructions 114, processing plant data 120, and/or other data can allow the fleet management controller 112 to model and predict likely future movements and operations of machines 102 at the worksite 100 that impact attributes of loads of material 104 that will be delivered to processing plants 106 over a future time period.

In some examples, the fleet management controller 112 can train a machine learning model, for instance using supervised machine learning or unsupervised machine learning, based on a sample of historical data that may include machine operational data 128, processing plant data 120, and/or other data described herein. The machine learning model may be based on convolutional neural networks, recurrent neural networks, other types of neural networks, nearest-neighbor algorithms, regression analysis, deep learning algorithms, Gradient Boosted Machines (GBMs), Random Forest algorithms, and/or other types of artificial intelligence or machine learning frameworks. The machine learning model can be trained to determine how changes to one or more types of data impact other types of data in the sample. As an example, the training of the machine learning model may indicate that particular types of changes in the processing plant data 120 impact how much and/or what types of material 104 crushers 108 can accept. Accordingly, after being trained, the machine learning model can indicate that if such changes are identified with processing plant data 120 newly received by the fleet management controller 112, corresponding changes should be made to projected delivery data 154 for a future time period.

The projected delivery data 154 can be continually, periodically updated over time as new information is received by the fleet management controller 112. For example, if a machine breaks down and reduces the total number of machines 102 operating at the worksite, the fleet management controller 112 can update the projected delivery data 154 to indicate that a lower amount of material is projected to be delivered to crushers 108 over the next three hours. As another example, if processing plant data 120 received from the plant management controller 116 indicates that one or more crushers 108 will be offline during a future time period, the fleet management controller 112 can update the projected delivery data 154 based on the indication that machines 102 will be unable to deliver material 104 to those crushers 108 during the future time period. As yet another example, if weather forecasting information indicates that a storm will arrive in an hour that is likely to slow movement of machines 102, the fleet management controller 112 can update the projected delivery data 154 to indicate a lower projected delivery rate of material 104 to crushers 108.

The plant management controller 116 can generate plant instructions 118 based on the projected delivery data 154. For example, if the projected delivery data 154 indicates that machines 102 are likely to begin delivering material 104 to crushers 108 at a slower than average delivery rate during an upcoming time period, the plant management controller 116 can generate plant instructions 118 that prepare processing plants 106 for an upcoming drop in material delivery rate. For example, the plant management controller 116 can generate plant instructions 118 that instruct a processing plant to prepare to process material 104 from a stockpile, rather than waiting for new material to be delivered by machines 102. Similarly, if the projected delivery data 154 indicates that machines 102 are likely to begin delivering material 104 at higher delivery rates, or are likely to begin delivering different types or grades of material, during a future period of time, the plant management controller 116 can generate plant instructions 118 that increasing processing rates of crushers 108 and/or other elements, activate and/or change speeds of conveyor belts 110 to move material 104 from crushers 108 and/or stockpiles in advance of the anticipated change in the type or grade of material that will be delivered during the future period of time.

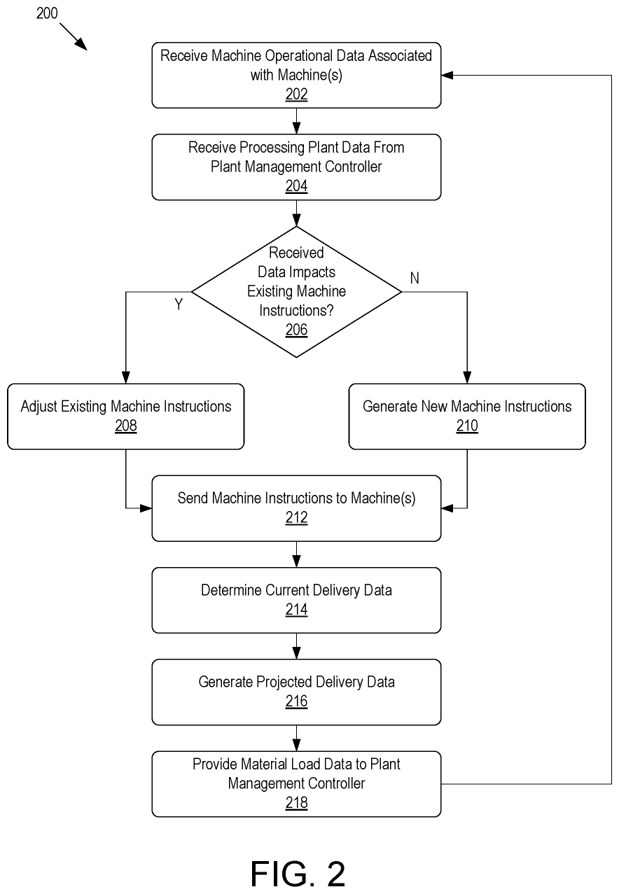

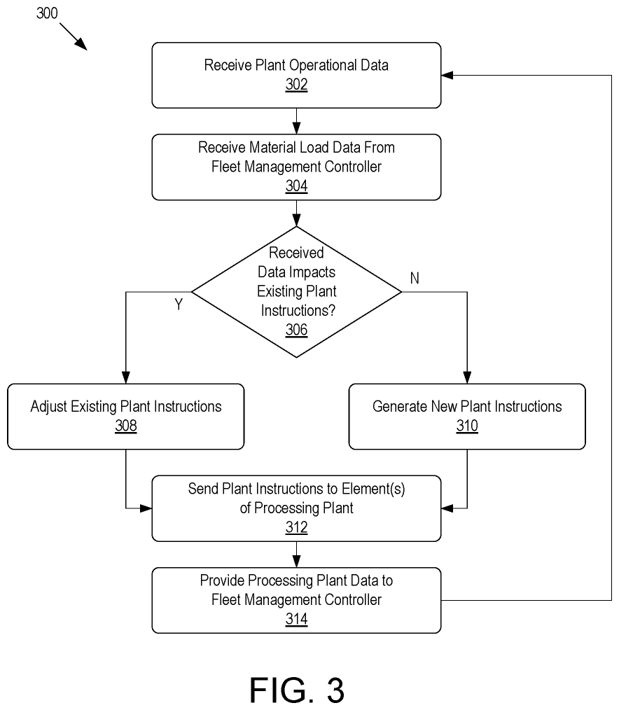

Overall, as described above, the fleet management controller 112 can dynamically control operations of machines 102 at the worksite 100 based at least in part on processing plant data 120 received from the plant management controller 116, for instance to account for changes in operations of elements of the processing plants 106. Similarly, the plant management controller 116 can dynamically control operations of elements of the processing plants 106 based at least in part on material load data 122 received from the fleet management controller 112, for instance to account for changes and/or anticipated changes in delivery rates of material 104 to crushers 108. Example processes for dynamically adjusting operations of the machines 102 and the processing plants 106 based on the exchange of processing plant data 120 and material load data 122 between the fleet management controller 112 and the plant management controller 116 are discussed further below with respect to FIG. 2 and FIG. 3.

FIG. 2 is a flowchart 200 illustrating an exemplary process for dynamically managing operations of machines 102 at the worksite 100, based at least in part on processing plant data 120 received from the plant management controller 116, in accordance with an embodiment of the present disclosure. The operations shown in FIG. 2 can be performed by the fleet management controller 112. FIG. 4, discussed further below, describes an example system architecture for the fleet management controller 112.

At block 202, the fleet management controller 112 can receive machine operational data 128 associated with one or more machines 102. The machine operational data 128 can indicate locations of the machines 102 at the worksite, travel speeds of the machines 102, attributes of loads of material 104 being transported by the machines 102, and/or any other information associated with the machines 102 and material 104 carried by the machines 102.

At block 204, the fleet management controller 112 can receive processing plant data 120 from the plant management controller 116. The fleet management controller 112 may receive processing plant data 120 that has been published via an API or other system to a data sharing platform by the plant management controller 116, via messages sent to the fleet management controller 112 by the plant management controller 116, and/or via other systems. As discussed above, the processing plant data 120 can indicate information associated with operations of the processing plants 106, such as material target data 144 associated with material 104 to be delivered to the processing plants 106, crusher operational data 146 associated with operations of crushers 108, material processing rate data 148 associated with rates at which elements of the processing plants are and/or can process material 104, and stockpile data 150 associated with material 104 in stockpiles at the processing plants 106. The processing plant data 120 can be determined by the plant management controller 116, for instance as discussed below with respect to FIG. 3.

At block 206, the fleet management controller 112 can determine whether the machine operational data 128 received at block 202 and/or the processing plant data 120 received at block 204 impacts existing machine instructions 114 previously generated and set to one or more machines 102. For example, if the processing plant data 120 indicates that a particular crusher will be associated with a closed indicator for the next fifteen minutes, and machine operational data 128 indicates that a machine that was previously instructed to deliver a load of material to the particular crusher is projected to arrive at the particular crusher in five minutes, the received data can impact existing machine instructions 114 because the machine may be unable to deliver the material to the particular crusher as planned. Other examples of how processing plant data 120 may impact operations of one or more machines 102 are discussed above.

If data received at block 202 and/or block 204 impacts existing machine instructions 114 (Block 206—Yes), the fleet management controller 112 can adjust the existing machine instructions 114 at block 208. For instance, in the example above in which processing plant data 120 indicates that a particular machine previously assigned to deliver a load of material 104 to a crusher is likely arrive at the crusher when the crusher is associated with a closed indicator, the fleet management controller 112 may send new machine instructions 114 that diverts the machine to deliver the load of material to a different crusher that is likely to be associated with an open indicator, or that diverts the machine to recharge or refuel until the originally-assigned crusher is likely to be associated with an open indicator.

If data received at block 202 and block 204 does not impact existing machine instructions 114 (Block 206—No), the fleet management controller 112 may generate new machine instructions 114 for one or more machines 102 at block 210. For example, based on current locations of machines 102 indicated by the machine operational data 128, and operational states of crushers 108 indicated by the processing plant data 120, the fleet management controller 112 can generate machine instructions 114 that dispatch one of the machines 102 to be loaded with material 104 and to deliver the material to a crusher that can accept the material 104.

At block 212, the fleet management controller 112 can send the adjusted machine instructions 114 generated at block 208, or the new machine instructions 114 generated at block 210, to the corresponding machine. The machine, or an operator of the machine, can thus follow the machine instructions 114 sent by the fleet management controller 112 at block 212.

At block 214, the fleet management controller 112 can determine current delivery data 152 associated with current loads of material 104 being transported to processing plants 106 by machines 102. For example, the fleet management controller 112 can determine the current delivery data 152 based on previous machine instructions 114 that dispatched machines 102 to deliver loads of material 104 to processing plants 106, based on the machine operational data 128 indicating current locations, speeds, material load data, and/or other attributes associated with machines 102, based on worksite data 132, and/or based on other types of data as discussed above.

At block 216, the fleet management controller 112 can generate projected delivery data 154 associated with loads of material 104 that are likely to be transported to processing plants 106 by machines 102 over a future time period, such as the next three hours or another future time period. The fleet management controller 112 can generate the projected delivery data 154 based on machine learning predictions, and/or other predictions of future movements and operations of material 104, machines 102, and/or other elements, based on future production schedules and/or plans, and/or based on other data as discussed above.

At block 218, the fleet management controller 112 can provide material load data 122, including the current delivery data 152 determined at block 212 and/or the projected delivery data 154 generated at block 214, to the plant management controller 116. For example, the fleet management controller 112 may publish the material load data 122 via an API or other system to a data sharing platform so that the published material load data 122 can be received or accessed by the plant management controller 116, may send the material load data 122 in electronic messages to the plant management controller 116, and/or share the material load data 122 with the plant management controller 116 via other systems.

The plant management controller 116 can use the material load data 122, provided at block 218, to dynamically control operations of the processing plants 106 as discussed below with respect to FIG. 3. The fleet management controller 112 can also return to block 202 to repeat the process shown in FIG. 2, for instance based on new machine operational data 128 received at block 202 and/or new processing plant data 120 received at block 204.

FIG. 3 is a flowchart 300 illustrating an exemplary process for dynamically managing operations of elements of a processing plant, based at least in part on material load data 122 received from the fleet management controller 112, in accordance with an embodiment of the present disclosure. The operations shown in FIG. 3 can be performed by the plant management controller 116. FIG. 4, discussed further below, describes an example system architecture for the plant management controller 116.

At block 302, the plant management controller 116 can receive plant operational data 142 associated with one or more elements of the processing plant. The plant operational data 142 can indicate operation statuses, processing rates, maintenance plans, sensor data, and/or any other information associated with crushers 108, conveyor belts 110, stockpiles, and/or other elements associated with the processing plant.

At block 304, the plant management controller 116 can receive material load data 122 from the fleet management controller 112. The plant management controller 116 may receive material load data 122 that has been published via an API or other system to a data sharing platform by the fleet management controller 112, via messages sent to the plant management controller 116 by the fleet management controller 112, and/or via other systems. As discussed above, the material load data 122 can include current delivery data 152 indicating attributes of loads of material 104 currently en route to the processing plant, and/or projected delivery data 154 indicating attributes of future loads of material 104 that are projected to be delivered to the processing plant during a future period of time. The material load data 122 can be determined by the fleet management controller 112, for instance as discussed above with respect to FIG. 2.

At block 306, the plant management controller 116 can determine whether the plant operational data 142 received at block 302 and/or the material load data 122 received at block 304 impacts existing plant instructions 118 previously generated and set to one or more elements of the processing plant. For example, if previous plant instructions 118 instructed elements of the processing plant to process material 104 from a stockpile instead of from a crusher, but the bin of that crusher is relatively full and material load data 122 indicates that a machine will be delivering a load of material 104 to that crusher in twenty minutes, the received data can impact existing plant instructions 118 because the crusher is not currently operating to reduce the fullness level of the bin in preparation for delivery of additional material 104.

If data received at block 302 and/or block 304 impacts existing plant instructions 118 (Block 306—Yes), the plant management controller 116 can adjust the existing plant instructions 118 at block 308. For instance, in the example above in which material load data 122 indicates that a load of material 104 will be delivered to a crusher in twenty minutes, current plant operational data 142 indicates that the bin of the crusher is relatively full, and the crusher is not currently operating to reduce the fullness level of the bin, the plant management controller 116 may send new plant instructions 118 that cause the processing plant to stop processing material from a stockpile and to instead have the crusher crush material 104 in the bin. Accordingly, the adjusted plant instructions 118 can cause the fullness level of the bin of the crusher to be reduced before the expected delivery of the load of material 104 indicated by the material load data 122 occurs.

If data received at block 302 and block 304 does not impact existing plant instructions 118 (Block 306—No), the plant management controller 116 may generate new plant instructions 118 for one or more elements of the processing plant at block 310. For example, if the material load data 122 indicates that zero machines 102 are likely to be present at a crusher during a period of time, the plant management controller 116 may determine to activate a rock breaker associated with the crusher during that period of time, and can generate new plant instructions 118 that cause the activation of the rock crusher.

At block 312, the plant management controller 116 can send the adjusted plant instructions 118 generated at block 308, or the new plant instructions 118 generated at block 310, to the corresponding elements of the processing plant. The elements of the processing plant can thus follow the plant instructions 118 sent by the plant management controller 116 at block 312.

At block 314, the plant management controller 116 can provide processing plant data 120, for example including material target data 144, crusher operational data 146, material processing rate data 148, stockpile data 150, and/or other types of data associated with operations of the processing plant, to the fleet management controller 112. The plant management controller 116 can generate the processing plant data 120 based on sensor data and/or other types of plant operational data 142 received at block 302. The plant management controller 116 can provide the processing plant data 120 to the fleet management controller 112 by publishing the processing plant data 120 via an API or other system to a data sharing platform so that the published processing plant data 120 can be received or accessed by the fleet management controller 112, by sending the processing plant data 120 in electronic messages to the fleet management controller 112, and/or by sharing the processing plant data 120 with the fleet management controller 112 via other systems.

The fleet management controller 112 can use the processing plant data 120, provided at block 314, to dynamically control operations of the machines 102 at the worksite 100 as discussed above with respect to FIG. 2. The plant management controller 116 can also return to block 302 to repeat the process shown in FIG. 3, for instance based on new plant operational data 142 received at block 302 and/or new material load data 122 received at block 304.

FIG. 4 is a schematic illustration depicting an exemplary architecture of a computing system 400 that executes one or more elements described in the present disclosure. The computing system 400 can include one or more processors 402, memory 404, and communication interfaces 406.

The fleet management controller 112 and the plant management controller 116 may each be implemented by one or more instances of the computing system 400. For example, a first instance of the computing system 400 associated with the fleet management controller 112 can be used to execute the exemplary process shown in FIG. 2, while a separate second instance the computing system 400 associated with the plant management controller 116 can be used to execute the exemplary process shown in FIG. 3. In other examples, an instance of the computing system 400 can be used to execute elements of both the fleet management controller 112 and the plant management controller 116. For example, the computing system 400 may execute the fleet management controller 112 and the plant management controller 116 as separate applications and/or in different virtual machines, different containers, or other different computing environments. Other computing systems described herein, such as the ECM 124 or other on-board computing systems of a machine, can also have a system architecture that is similar to the system architecture shown in FIG. 4.

The processor(s) 402 can operate to perform a variety of functions as set forth herein. The processor(s) 402 can include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 402 can have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 402 can also access content and computer-executable instructions stored in the memory 404, and execute such computer-executable instructions.

The memory 404 can be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media can be non-transitory computer-readable media. The computer-readable media can be configured to store computer-executable instructions that can be executed by the processor(s) 402 to perform the operations described herein.

For example, the memory 404 can include a drive unit and/or other elements that include machine-readable media. A machine-readable medium can store one or more sets of instructions, such as software or firmware, that embodies any one or more of the methodologies or functions described herein. The instructions can also reside, completely or at least partially, within the processor(s) 402 and/or communication interface(s) 406 during execution thereof by the computing system 400. For example, the processor(s) 402 can possess local memory, which also can store program modules, program data, and/or one or more operating systems.

The memory 404 can store data and/or computer-executable instructions associated with an operational controller 408, an instruction generator 410, a communication manager 412, and/or a data sharing platform 414. The memory 404 can also store other modules and data 416 that can be utilized by the computing system 400 to perform or enable performing any action taken by the computing system. For example, the other modules and data 416 can include a platform, operating system, and/or applications, as well as data utilized by the platform, operating system, and/or applications.

The operational controller 408 can be configured to control operations of machines 102 or elements of one or more processing plants 106. For example, if the computing system 400 is the fleet management controller 112, the operational controller 408 can use machine operational data 128, worksite data 132, processing plant data 120, and/or other data to determine how and when to dispatch and/or assign machines 102 to perform operations at the worksite 100. As another example, if the computing system 400 is the plant management controller 116, the operational controller 408 can use plant operational data 142, material load data 122, and/or other data to determine how and when to cause crushers 108, conveyor belts 110, and/or other elements of processing plants 106 to perform operations.

The instruction generator 410 can be configured to generate machine instructions 114 or plant instructions 118. For example, if the computing system 400 is the fleet management controller 112, the instruction generator 410 can generate machine instructions 114 that instruct or otherwise cause one or more machines 102 to perform operations determined by the operational controller 408. As another example, if the computing system 400 is the plant management controller 116, the instruction generator 410 can generate plant instructions 118 that instruct or otherwise cause elements of one or more processing plants 106 to perform operations determined by the operational controller 408.

The communication manager 412 can be configured to send and receive data, for instance via the communication interfaces 406. For example, if the computing system 400 is the fleet management controller 112, the communication manager 412 can receive machine operational data 128 from one or more machines 102 and send machine instructions 114 to the one or more machines 102, and may use electronic messages, the data sharing platform 414, or other systems to receive processing plant data 120 from the plant management controller 116 and to provide material load data 122 to the plant management controller 116. As another example, if the computing system 400 is the plant management controller 116, the communication manager 412 can receive plant operational data 142 from elements of one or more processing plants 106 and send plant instructions 118 to the elements of the one or more processing plants 106, and may use electronic messages, the data sharing platform 414, or other systems to receive material load data 122 from the fleet management controller 112 and to provide processing plant data 120 to the fleet management controller 112.

The data sharing platform 414 may be associated with one or more APIs or other interfaces or systems that is provided by one or both of the fleet management controller 112 and the plant management controller 116, and that allow the fleet management controller 112 and the plant management controller 116 to share data and communicate bidirectionally. For example, the data sharing platform 414 may be configured to allow the fleet management controller 112 to publish or share material load data 122, such that the material load data 122 can be accessed by the plant management controller 116. As another example, the data sharing platform 414 may be configured to allow the plant management controller 116 to publish or share processing plant data 120, such that the processing plant data 120 can be accessed by the fleet management controller 112.

The communication interfaces 406 can include transceivers, modems, interfaces, antennas, and/or other components that can transmit and/or receive data over networks or other data connections. In some examples, the communication interfaces 406 can be wired communication interfaces and/or wireless communication interfaces 130 that the computing system 400 can use to send and/or receive data, such as one or more of the machine instructions 114, machine operational data 128, processing plant data 120, material load data 122, plant operational data 142, and plant instructions 118 described herein.

### INDUSTRIAL APPLICABILITY

As described above, the fleet management controller 112 and the plant management controller 116 can communicate bidirectionally, to exchange processing plant data 120 associated with operations of one or more processing plants 106 and material load data 122 associated with loads of material 104 transported by machines 102 to the processing plants 106. Accordingly, the fleet management controller 112 can dynamically control operations of machines 102 at the worksite 100 based at least in part on the operations of the processing plants 106 indicated by the processing plant data 120, and the plant management controller 116 can dynamically control operations of elements of the processing plants 106 based on attributes of loads of material 104 that are being delivered or will be delivered to the processing plants as indicated by the material load data 122. The bidirectional communication between the fleet management controller 112 and the plant management controller 116 can improve productivity of both machines 102 at the worksite 100 and of the processing plants 106.

For example, some previous systems may allow a fleet management system to track attributes of material delivered to crushers of a processing plant, for instance to determine if the delivered material causes a cumulative blend of material at a crusher to meet blend targets requested by an operator of the processing plant or to adjust operations of machines if delivered material causes the cumulative blend of material at the crusher to be outside the requested blend targets. However, in such previous systems, a fleet management system may not be provided with information about actual processing rates of crushers, planned or unplanned downtime of crushers, open and closed indicators associated with crushers, rock breaker operations, and/or other operations of crushers or other elements of the processing plants. Accordingly, a fleet management system in previous systems may dispatch machines to deliver loads of material to a crusher when the crusher will be offline for maintenance, be associated with a closed indicator, be associated with an active rock breaker, or will otherwise be unable to accept delivery of the material. In these situations, dispatched machines may queue at or near the crusher until the crusher can accept the loads of material being transported by the machines.

However, the fleet management controller 112 described herein can be notified of such operations of a processing plant, via the processing plant data 120. Accordingly, the fleet management controller 112 can divert machines 102 to other crushers or processing plants when a crusher will be unable to accept material 104, and/or otherwise adjust operations of machines 102 in response to operations of a processing plant. As such, machines 102 controlled by the fleet management controller 112, and movement of material 104 from the worksite 100, can be more productive and/or more efficient overall.

As another example, in some previous systems, a processing plant system may not be provided with information about material being processed by crushers and/or other elements of a processing plant until after the material is delivered to the processing plant. Accordingly, in such previous systems a processing plant system may be unable to adjust operations of the processing plant in advance of deliveries, to prepare for the processing of particular loads of material that have particular attributes.

However, the plant management controller 116 described herein can be notified of attributes of loads of material 104 that are en route to a processing plant, and/or that are expected to be delivered to the processing plant during a future period of time, via the material load data 122. Accordingly, the plant management controller 116 adjust operations of crushers 108 and other elements to reduce bin fullness levels, adjust material processing rates, activate or deactivate rock breakers 138, and/or otherwise adjust operations of elements of the processing plant before the loads of material 104 arrive, such that the processing plant can be better prepared to process the loads of material 104 when the material 104 is delivered. As such, elements of the processing plants 106 controlled by the plant management controller 116, and the processing of material 104 at the processing plants 106, can be more productive and/or more efficient overall.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A computer-implemented method comprising:
receiving, by a fleet management controller, processing plant data from a plant management controller associated with a processing plant, wherein:
the fleet management controller is configured to control first operations of a fleet of machines at a worksite to deliver loads of material to the processing plant,
the plant management controller is configured to control second operations of the processing plant that process the loads of material delivered by the fleet of machines, and
the processing plant data is indicative of the second operations of the processing plant; and
generating, by the fleet management controller, and based at least in part on the processing plant data, machine instructions that adjust the first operations of the fleet of machines in response to the second operations of the processing plant; and
sending, by the fleet management controller, the machine instructions to the fleet of machines.

2. The computer-implemented method of claim 1 further comprising:
generating, by the fleet management controller, material load data indicative of one or more of current and projected future loads of material that will be delivered by the fleet of machines to the processing plant; and
providing, by the fleet management controller, the material load data to the plant management controller, wherein the material load data causes the plant management controller to adjust the second operations of the processing plant prior to delivery of the one or more of the current and projected future loads of material.

3. The computer-implemented method of claim 1, wherein the processing plant data includes crusher operational data, associated with one or more crushers of the processing plant, indicating one or more of:
current statuses of the one or more crushers;
planned maintenance times associated with the one or more crushers;
current bin fullness levels of the one or more crushers;
threshold fullness levels corresponding to closed indicators associated with the one or more crushers; and
operational statuses of rock breakers associated with the one or more crushers.

4. The computer-implemented method of claim 1, wherein the processing plant data includes material processing rate data indicating one or more of:
current material processing rates of one or more crushers of the processing plant; and
changes to material processing rates of the one or more crushers over a period of time.

5. The computer-implemented method of claim 1, wherein the processing plant data includes material target data indicating one or more material modifiers of the material the processing plant is accepting for processing.

6. The computer-implemented method of claim 1, wherein the processing plant data includes stockpile data indicating fullness levels of one or more stockpiles of the material the processing plant has available to process.

7. The computer-implemented method of claim 1, wherein:
the processing plant data indicates that at least a first crusher of the processing plant will be unable to accept material during a period of time, and
the machine instructions adjust the first operations to divert one or more machines, in the fleet of machines, to deliver the loads of material to one or more different crushers of the processing plant or a different processing plant during the period of time.

8. The computer-implemented method of claim 1, wherein:
the processing plant data indicates, to the fleet management controller, a decrease in a material processing rate over a period of time, and
the machine instructions adjust the first operations to reduce a material delivery rate, associated with delivery of the loads of material to the processing plant, to correspond with the decrease in the material processing rate.

9. The computer-implemented method of claim 1, wherein the worksite is a mine site, the material is ore excavated at the mine site, and the processing plant is configured to extract one or more types of minerals from the ore.

10. A fleet management controller comprising:
a processor; and
a memory having stored thereon computer-executable instructions that when executed by the processor cause the processor to:
generate machine instructions that control first operations of a fleet of machines at a worksite, wherein the first operations cause the fleet of machines to deliver loads of material to a processing plant;
receive processing plant data from a plant management controller that is configured to control second operations of the processing plant that process the loads of material delivered by the fleet of machines, wherein the processing plant data is indicative of the second operations of the processing plant; and
adjust the machine instructions, based at least in part on the processing plant data, to change the first operations of the fleet of machines in response to the second operations of the processing plant.

11. The fleet management controller of claim 10, wherein the processing plant data includes crusher operational data, associated with one or more crushers of the processing plant, indicating one or more of:
current statuses of the one or more crushers;
planned maintenance times associated with the one or more crushers;
current bin fullness levels of the one or more crushers;
threshold fullness levels corresponding to closed indicators associated with the one or more crushers; and
operational statuses of rock breakers associated with the one or more crushers.

12. The fleet management controller of claim 10, wherein the processing plant data includes material processing rate data indicating one or more of:
current material processing rates of one or more crushers of the processing plant; and
changes to material processing rates of the one or more crushers over a period of time.

13. The fleet management controller of claim 10, wherein:
the processing plant data indicates that a first crusher of the processing plant will be unable to accept material during a period of time, and
the machine instructions are adjusted to divert one or more machines, in the fleet of machines, to deliver the loads of material to one or more different crushers of the processing plant or a different processing plant during the period of time.

14. The fleet management controller of claim 10, wherein:
the processing plant data indicates a decrease in a material processing rate over a period of time, and
the machine instructions are adjusted to reduce a material delivery rate, associated with delivery of the loads of material to the processing plant, to correspond with the decrease in the material processing rate.

15. A worksite system comprising:
a plurality of machines at a worksite, wherein individual machines, of the plurality of machines, are configured to be loaded with material at the worksite, and to deliver the material to one or more crushers associated with at least one processing plant configured to process the material; and
a fleet management controller associated with the plurality of machines, wherein the fleet management controller is configured to:
manage first operations of the plurality of machines at the worksite;
provide first data, indicative of the first operations of the plurality of machines, to a plant management controller associated with the at least one processing plant;
receive second data, indicative of second operations of the at least one processing plant, from the plant management controller;
generate, based at least in part on the second data, machine instructions that adjust the first operations of the plurality of machines in response to the second operations of the at least one processing plant; and
send the machine instructions to the plurality of machines; and
the plant management controller associated with the at least one processing plant, wherein the plant management controller is configured to:
manage the second operations of the at least one processing plant;
provide the second data to the fleet management controller;
receive the first data from the fleet management controller;
generate, based at least in part on the first data, plant instructions that adjust the second operations of the at least one processing plant in response to the first operations of the plurality of machines; and
send the plant instructions to the at least one processing plant.

16. The worksite system of claim 15, wherein:
the first data comprises material load data indicative of one or more of current and projected future loads of material that, based on a current set of the machine instructions, will be delivered by the plurality of machines to the one or more crushers, and
the plant management controller generates the plant instructions, based on the material load data, to adjust the second operations of the at least one processing plant in anticipation of delivery of the one or more of the current and projected future loads of material.

17. The worksite system of claim 16, wherein the material load data indicates one or more of:
at least one amount of the material associated with the one or more of the current and projected future loads of material;
at least one material type associated with the one or more of the current and projected future loads of material;
at least one material grade associated with the one or more of the current and projected future loads of material;
at least one material size associated with the one or more of the current and projected future loads of material;
at least one identifier of the one or more crushers to which the one or more of the current and projected future loads of material will be delivered; and
at least one arrival time of the one or more of the current and projected future loads of material to the one or more crushers.

18. The worksite system of claim 15, wherein the second data includes crusher operational data, associated with the one or more crushers, indicating one or more of:
current statuses of the one or more crushers;
planned maintenance times associated with the one or more crushers;
current bin fullness levels of the one or more crushers;
threshold fullness levels corresponding to closed indicators associated with the one or more crushers; and
operational statuses of rock breakers associated with the one or more crushers.

19. The worksite system of claim 15, wherein:
the second data indicates that a first crusher, of the one or more crushers, will be unable to accept material during a period of time, and
the fleet management controller generates the machine instructions to divert one or more machines, in the plurality of machines, to deliver the material to one or more different crushers, of the one or more crushers, during the period of time.

20. The worksite system of claim 15, wherein:
the second data indicates a decrease in a material processing rate associated with the one or more crushers over a period of time, and
the fleet management controller generates the machine instructions to reduce a material delivery rate, associated with delivery of the material to the processing plant, to correspond with the decrease in the material processing rate.
